(19) United States
(12) Patent Application Publication
(10) Pub. No.: US 2005/0229205 A1
(43) Pub. Date: Oct. 13, 2005

(54) Encrypted trigger and associated methods

(76) Inventors: Alan Azralon, Holtsville, NY (US); Patrick J. Donoghue, Sea Cliff, NY (US); Edgar McLaughlin, Lloyd Harbor, NY (US)

Correspondence Address: KENYON & KENYON, 1500 K STREET NW, SUITE 700, WASHINGTON, DC, 20005, US

(21) Appl. No.: 10/822,788

(22) Filed: Apr. 13, 2004

(51) Int. Cl. H04N 5/445; H04N 7/167; H04N 7/16; G06F 13/00

(52) U.S. Cl. 725/28; 725/46; 725/25; 725/135

(57) ABSTRACT

An apparatus, systems and methods control access to an enhancement within a trigger. A portion of a trigger is encrypted and included within the trigger. The trigger with the encrypted portion is then included within a signal. When it is determined that a signal is received with the trigger, the encrypted portion is decrypted and compared to predetermined criteria. If the decrypted portion meets the predetermined criteria, display of an enhancement within the trigger is allowed.

### TECHNICAL FIELD

The present invention relates to methods and systems for controlling access to an enhancement within a trigger.

### BACKGROUND OF THE INVENTION

Interactive video systems have recently been developed that can allow a viewer to interact with video the viewer is watching. Such systems may be used with television, cable television, satellite, the Internet or other systems to allow a viewer to receive additional information about a topic in the program being viewed, for example. Also, the user could be allowed to order a product described in the video program, such as allowing the viewer to order a product in a commercial being viewed.

An Enhanced Content Specification has been developed by the Advanced Television Enhancement Forum (ATVEF) to specify a single public standard for delivering interactive television to a variety of television, set-top and PC-based receivers. The Enhanced Content Specification defines fundamentals necessary to enable creation of enhanced television content so that it can be broadcast across any network to any compliant receiver. It uses “triggers” to launch the enhancements. The triggers include a Uniform Resource Locator (URL) that contains a link to the enhancement, which may be a website, for example.

The trigger may result in the creation of an icon on the viewer's screen. The icon may typically include wording that will be displayed with the video asking the user if additional information is desired. Such wording may be set up in accordance with the topic of the video program being viewed. For example, if the user is watching a sporting event, the trigger may result in an icon being displayed saying “STATISTICS”, or if a commercial is being viewed, the trigger may result in an icon being displayed saying “BUY PRODUCT”.

The user may be able to select the icon by hitting an appropriate button on a remote control or placing a cursor over the icon and activating a mouse, for example. Selection of the icon may result in initiation of the enhancement, where the viewer can be presented with additional information, such as the “STATISTICS” or information on how to buy a product. Typically, the trigger may be generated and inserted into a video signal by a content creator, who originates the content of the program, as well as the content components of the enhancement, including graphics, layout, interaction and triggers.

A transport operator, such as a cable television operator, will run a delivery infrastructure, that may include servers or other units that deliver the video program and the enhancements. Upon activation of the trigger, the transport operator may deliver the triggered enhancement. The transport operator will deliver the content to the user, along with the triggers. However, every content provider can insert triggers within it's content, which may create problems. The transport operator may not wish to enable a large number of triggers, or the transport operator may want to decide which triggers to enable. Current systems, however, do not allow the transport operator to select which triggers to enable when the content providers supply the program content with triggers included.

### SUMMARY OF THE INVENTION

An apparatus, systems and methods control access to an enhancement within a trigger. A portion of a trigger is encrypted and included within the trigger. The trigger with the encrypted portion is then included within a signal. When it is determined that a signal is received with the trigger, the encrypted portion is decrypted and compared to predetermined criteria. If the decrypted portion meets the predetermined criteria, display of an enhancement within the trigger is allowed.

### BRIEF DESCRIPTION OF THE DRAWINGS

FIG. 1 is a block diagram in accordance with an embodiment of the present invention.

FIG. 2 is a block diagram in accordance with an embodiment of the present invention.

FIG. 3 illustrates a trigger in accordance with an embodiment of the present invention.

FIG. 4 is a trigger in accordance with an embodiment of the present invention.

FIG. 5 is a flowchart in accordance with an embodiment of the present invention.

FIG. 6 is a flow chart in accordance with an embodiment of the present invention.

FIG. 7 is a flowchart in accordance with an embodiment of the present invention.

### DETAILED DESCRIPTION

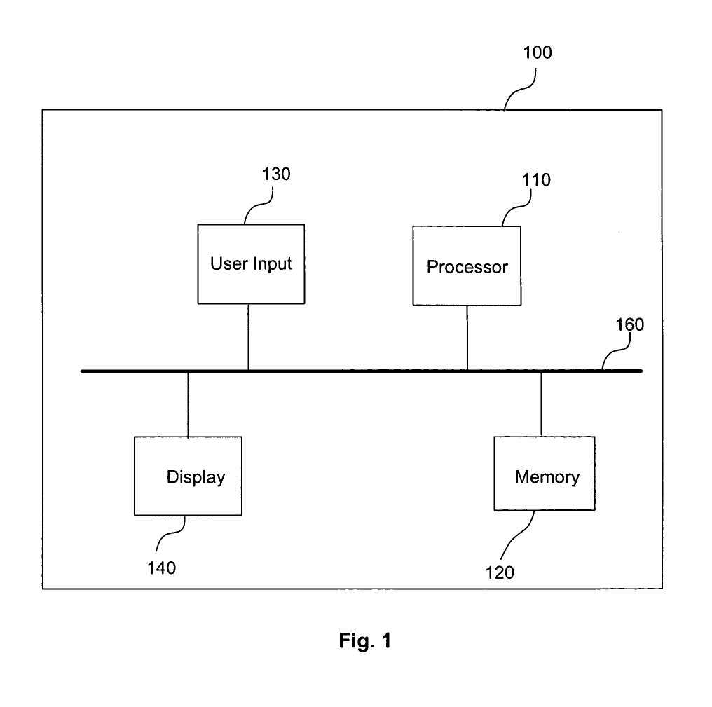

FIG. 1 depicts a block diagram of an embodiment of the present invention. Computing device 100 is suitable for use with the present invention. The computing device 100 may include a processor 110, a memory 120, a user input 130 and a display 140. The memory 120 may contain software to be run in conjunction with processor 110, and may cause images to be displayed on display 140. The software may be specifically designed to cause computing device 100 to implement the present invention. Computing device 100 may be one of various types of computing devices, such as a workstation, a personal computer, a server, a headend in a cable system, or any other type of computing device.

The processor 110 may be a general-purpose microprocessor, such a Pentium series microprocessor manufactured by the Intel Corporation of Santa Clara, Calif. In another embodiment, the processor 110 can be an Application Specific Integrated Circuit (ASIC), which has been designed to implement in its hardware and/or firmware at least a part of a method in accordance with embodiments of the present invention.

Memory 120 can be any device capable of storing analog or digital information, such as a hard disk, Random Access Memory (RAM), Read Only Memory (ROM), flash memory, a compact disk, a magnetic tape, a floppy disk, and any combination thereof, for example.

User input 130 can be any type of input device, such as a keyboard, keypad, pointing device, microphone, mouse, wired or wireless remote control, touch pad, touch screen, a port(s) to attach other input devices, voice recognition software, etc. Any type of input device will function in accordance with embodiments of the present invention.

The display 140 can be any type of display or screen that is capable of displaying images. For example, the display may be a CRT or LCD monitor, a heads-up display, a television, etc. The display 140 may be structurally included as part of the electronic device, or may be physically separated from but connected with the other components of device 100, such as a monitor in a desktop computer.

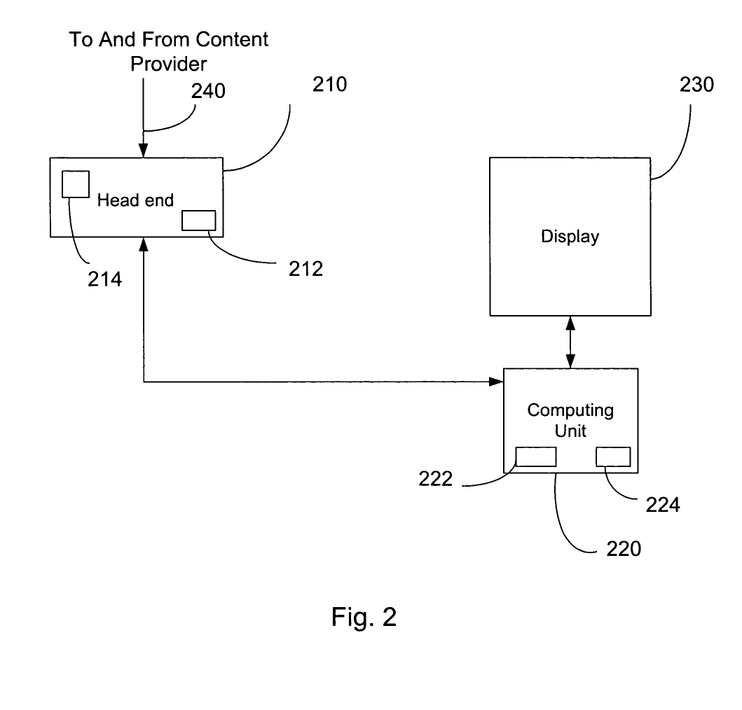

FIG. 2 depicts a block diagram of an embodiment of the present invention. Headend 210 may be the headend of a cable television provider or of an Internet Service Provider (ISP), for example. The headend 210 may receive programming 240 from content providers. The programming 240 may be received by satellite, via cables, over airwaves, be delivered on tape, etc. The programming may include enhanced programming having triggers including a URL that contains a link to an enhancement, such as a website. The triggers may be inserted into a vertical blanking interval (VBI) portion of the signal, for example. The headend 210 may transmit the programming and other information, such as the triggers and a programming guide, to customers. The customers may receive the programming via a computing unit 220. The computing unit 220 may be a personal computer, or may be a set top box used to receive programming. The programming may be delivered over a fiber optic link, or by other methods, such as receipt over a satellite dish (not shown). The programming may be viewed on a display 230.

The headend 210 may include a processor 212 and a memory 214. The memory 214 may have software stored therein to be used by processor 212 to encrypt at least a portion of a trigger, as further explained below. The computing unit 220 may include a processor 222 and a memory 224. The memory may have software stored therein to be used by the processor 222 to decrypt an encrypted portion of a trigger, as further described below. The decryption algorithm may be downloaded to the computing unit 220, or may be pre-stored in the memory of the computing unit 220.

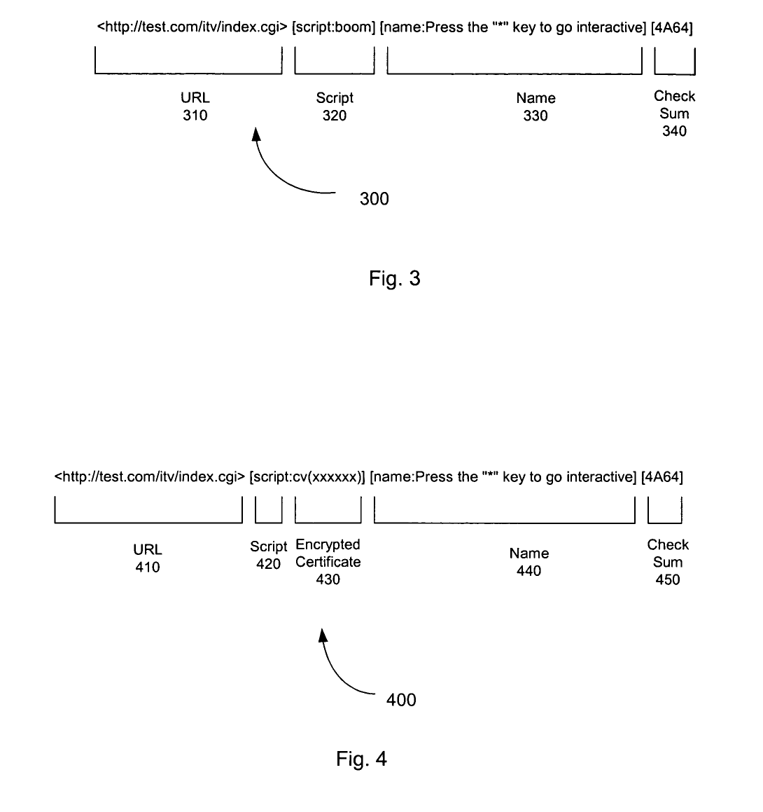

FIG. 3 illustrates a trigger 300 that can be used to launch an enhancement. Trigger 300 may include a Uniform Resource Locator (URL) 310, a script 320, a name 330, which may be indicative of the functionality of the enhancement, and a check sum 340. The general format of trigger 300 is set forth in Advanced Television Enhancement Forum (ATVEF) Enhanced Content Specification, version, the subject matter of which is incorporated herein in its entirety.

FIG. 4 illustrates a trigger 400 that may be used in accordance with embodiments of the present invention. Trigger 400 includes URL 410, a script 420, a name 440, and a check sum 450. In addition, trigger 400 includes an encrypted certificate 430. The encrypted certificate 430 is used to determine whether the enhancement used to activate the trigger will be displayed to a user or not, as further explained below.

The encrypted certificate may be generated by taking the URL 410 and running it through an encryption algorithm. No particular encryption algorithm is required. Various types of encryption algorithms may be used as known by those of skill in the art. Optionally, the encrypted certificate may include activation and/or deactivation dates, which may be used to set dates when the encrypted certificate will be deemed to be valid, as further explained below.

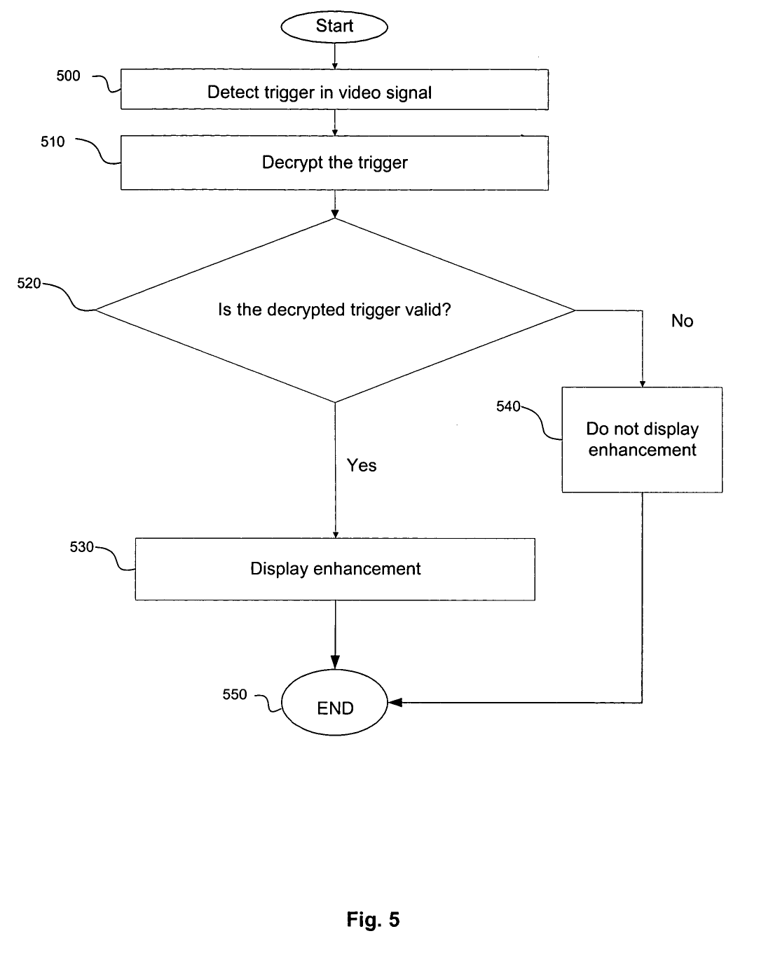

FIG. 5 illustrates a flowchart that may be used in accordance with an embodiment of the present invention. In step 500, a trigger is detected in a video signal. As explained above, the trigger may be in a VBI of the video signal. The video signal may be a video signal generated in a cable television system. The detection of the trigger may occur in computing unit 220 illustrated in FIG. 2, for example, which may be a set top box of a cable television system.

In step 510, the trigger is decrypted. Decrypting the trigger involves removing the encrypted certificate value from the rest of the trigger, and decrypting the encrypted certificate. The decryption may occur in the computing unit 220, or in head end 210, or in a server or other computing unit that replaces head end 210 in the embodiment of FIG. 2. A decryption algorithm is used that is designed based on the encryption algorithm mentioned above. Like the encryption algorithm, no particular algorithm is required, and those of skill in the art could design different algorithms that would work in conjunction with the various embodiments of the present invention.

In step 520, it is determined whether the decrypted trigger is valid. This step may involve comparing the decrypted certificate value to the URL (such as URL 410). If the decrypted certificate value matches the URL, the process moves to step 530, where the enhancement may be displayed to a user, on a display, such as display 230. If the decrypted certificate value does not match the URL, the process moves to step 540, and the enhancement is not displayed to the user.

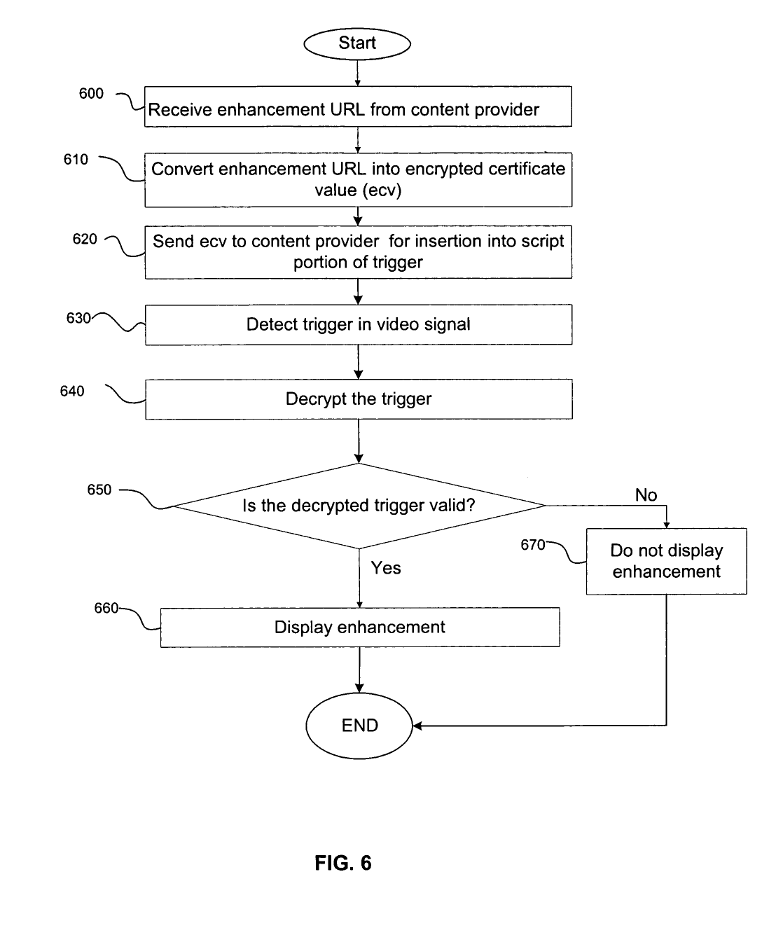

FIG. 6 illustrates a flowchart that may be used in accordance with an embodiment of the present invention. In step 600, an enhancement URL is received. In step 610, the enhancement URL is converted into an encrypted certificate value by use of an encryption algorithm, as discussed above.

In step 620, the encrypted certificate value is sent to the content provider. The content provider may be instructed to include the encrypted certificate value in the script portion of the trigger. In step 630, the trigger is detected in the video signal. In step 640, the trigger is decrypted, by decrypted the encrypted certificate value in the trigger.

In step 650, it is determined whether the decrypted certificate value is valid. This may be done by comparing the decrypted certificate value to the URL in the trigger. If the decrypted certificate value is determined to be valid, the enhancement may be displayed to the user in step 660. If the decrypted certificate value is determined not to be valid, then the enhancement is not displayed to the user in step 670.

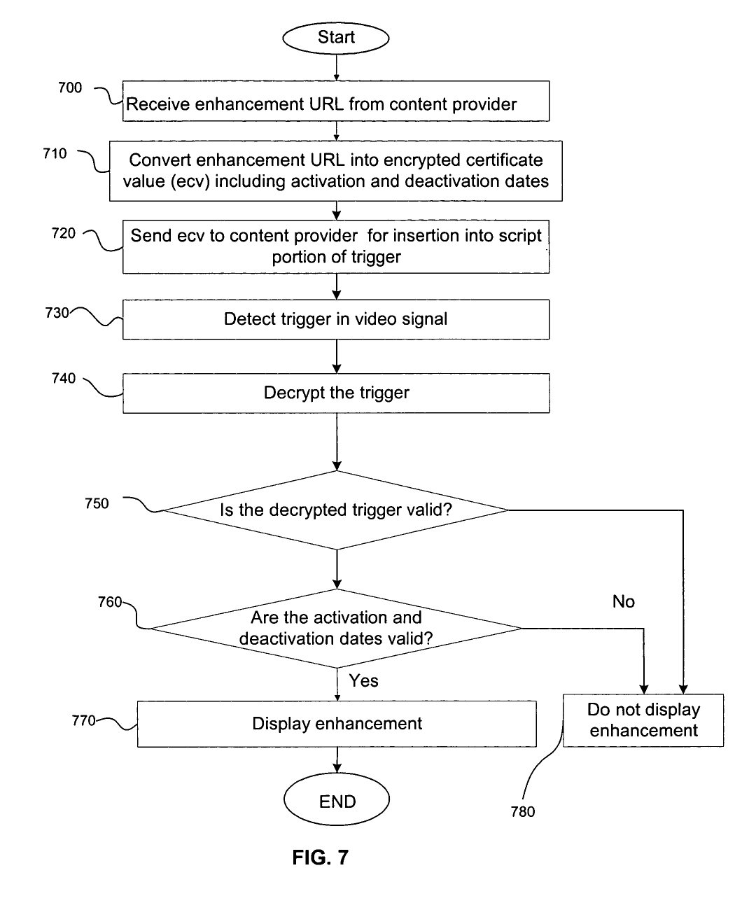

FIG. 7 illustrates a flowchart that may be used in accordance with an embodiment of the present invention. In step 700, an enhancement URL is received. The enhancement URL may be received from a content provider. The enhancement URL is a URL that will be used with a trigger for an enhancement. For example, the enhancement provider may be received by a cable company from a provider of programming content.

In step 710, the enhancement URL is converted into an encrypted certificate value by use of an encryption algorithm, as discussed above. The encrypted certificate value may optionally include an activation date, a deactivation date, or both, although these are not required. The activation and deactivation dates may be provided by the content provider, or by the party that receives the enhancement URL.

In step 720, the encrypted certificate value is sent to the content provider. The content provider may be instructed to insert the encrypted certificate value in the script portion of the trigger.

In step 730, a trigger is detected in a video signal. The trigger may be in a VBI of a video signal, as discussed above. The trigger may be detected in computing unit 220 illustrated in FIG. 2, for example, which may be a set top box of a cable television system.

In step 740, the trigger is decrypted. Decrypting the trigger involves removing the encrypted certificate value from the rest of the trigger, and decrypting the encrypted certificate, as discussed above. If the encrypted certificate value includes the activation date and/or the deactivation date, then these elements will also be decrypted as part of the encrypted certificate value.

In step 750, it is determined whether the decrypted trigger is valid. This step may involve comparing the decrypted certificate value to the URL (such as URL 410). If the decrypted certificate value is determined to be valid, the process may move to step 760 (step 760 may be skipped if the optional activation and deactivation dates are not included). If the decrypted certificate value is determined not to be valid, then the enhancement is not displayed to the user in step 780.

If the decrypted certificate value includes an activation date, then the activation date is compared to the current date in step 760. If the current date is prior to the activation date, then the enhancement is not displayed to the user in step 780. If the decrypted certificate value includes a deactivation date, then the deactivation date is compared to the current date in step 760. If the current date is subsequent to the deactivation date, then the enhancement is not displayed to the user in step 780.

If the decrypted trigger is determined to be valid, and the activation and deactivation dates (if included) are valid, then the enhancement may be displayed to the user in step 770.

The present invention described above allows the provider of programming from multiple sources to control when enhancements will be displayed to a user. This is useful because the content providers may otherwise provide enhancements in triggers that the provider of programming, such as a cable company or Internet service provider, may not want to be displayed to a user.

Several embodiments of the present invention are specifically illustrated and described herein. However, it will be appreciated that modifications and variations of the present invention are covered by the above teachings and within the purview of the appended claims without departing from the spirit and intended scope of the invention.

1. A method for controlling access to an enhancement within a trigger, comprising:
encrypting a portion of the trigger;
determining whether a received signal includes the trigger;
decrypting the portion of the trigger; and
if the decrypted portion meets predetermined criteria, allowing display of the enhancement to a user.

2. The method of claim 1, further comprising preventing display of the enhancement to the user when the decrypted portion does not meet the predetermined criteria.

3. The method of claim 1, wherein encrypting a portion of the trigger comprises encrypting a uniform resource locator portion of the trigger.

4. The method of claim 3, wherein encrypting a portion of the trigger further comprises inserting the encrypted uniform resource locator into a script portion of the trigger.

5. The method of claim 1, wherein determining whether the decrypted portion meets predetermined criteria comprises comparing the decrypted portion of the trigger to a uniform resource locator portion of the trigger.

6. The method of claim 1, wherein encrypting a portion of the trigger comprises inserting an activation date and/or a deactivation date into the encrypted portion of the trigger.

7. The method of claim 6, wherein determining whether the decrypted portion meets predetermined criteria comprises comparing whether the activation date is prior to a current date.

8. The method of claim 6, wherein determining whether the decrypted portion meets predetermined criteria comprises comparing whether the deactivation date is subsequent to a current date.

9. A method of controlling access to an enhancement within a trigger, comprising:
receiving a portion of a trigger;
encrypting the portion of the trigger;
sending the encrypted portion to be included with the trigger;
determining whether a signal includes the trigger;
decrypting the encrypted portion of the trigger; and
if the decrypted portion meets predetermined criteria, allowing display of the enhancement to a user.

10. The method of claim 9, further comprising preventing display of the enhancement to the user when the decrypted portion does not meet the predetermined criteria.

11. The method of claim 9, wherein encrypting a portion of the trigger comprises encrypting a uniform resource locator portion of the trigger.

12. The method of claim 11, wherein encrypting a portion of the trigger further comprises inserting the encrypted uniform resource locator into a script portion of the trigger.

13. The method of claim 9, wherein determining whether the decrypted portion meets predetermined criteria comprises comparing the decrypted portion of the trigger to a uniform resource locator portion of the trigger.

14. The method of claim 13, wherein determining whether the decrypted portion meets predetermined criteria comprises comparing whether the activation date is prior to a current date.

15. The method of claim 13, wherein determining whether the decrypted portion meets predetermined criteria comprises comparing whether the deactivation date is subsequent to a current date.

16. An apparatus to control access to an enhancement within a trigger, comprising:
a processor;
a memory to store instructions to be executed by the processor, the instructions including instructions to:
determining whether a received signal includes the trigger;
decrypting a portion of the trigger; and
if the decrypted portion meets predetermined criteria, allowing display of the enhancement to a user.

17. The apparatus of claim 16, wherein the instructions further include instructions to prevent display of the enhancement to the user when the decrypted portion does not meet the predetermined criteria.

18. The apparatus of claim 16, wherein the instructions to determine whether the decrypted portion meets predetermined criteria comprise instructions to compare the decrypted portion of the trigger to a uniform resource locator portion of the trigger.

19. The apparatus of claim 16, wherein the instructions to determine whether the decrypted portion meets predetermined criteria comprises instructions to compare whether an activation date in the decrypted portion is prior to a current date.

20. The apparatus of claim 16, wherein the instructions to determine whether the decrypted portion meets predetermined criteria comprises instructions to determine whether the deactivation date is subsequent to a current date.

21. A system to control access to an enhancement within a trigger, comprising:
a first computing unit to receive a portion of a trigger, encrypt the portion of the trigger, and send the encrypted portion to be included with the trigger;
a second computing unit to receive a signal, determine whether the signal includes the trigger, decrypt the encrypted portion of the trigger, and if the decrypted portion meets predetermined criteria, allow display of the enhancement to a user.

22. The system of claim 21, wherein the second computing unit prevents display of the enhancement to the user when the decrypted portion does not meet the predetermined criteria.

23. The system of claim 21, wherein encrypting a portion of the trigger comprises encrypting a uniform resource locator portion of the trigger.

24. The system of claim 23, wherein encrypting a portion of the trigger further comprises inserting the encrypted uniform resource locator into a script portion of the trigger.

25. The system of claim 21, wherein determining whether the decrypted portion meets predetermined criteria comprises comparing the decrypted portion of the trigger to a uniform resource locator portion of the trigger.

26. The system of claim 21, wherein determining whether the decrypted portion meets predetermined criteria comprises comparing whether the activation date is prior to a current date.

27. The system of claim 21, wherein determining whether the decrypted portion meets predetermined criteria comprises comparing whether the deactivation date is subsequent to a current date.

28. An apparatus to control access to an enhancement in a trigger, comprising:
a processor;
a memory to store instructions to be executed by the processor, the instructions including instructions to:
receive at least a portion of the trigger;
encrypt the portion of the trigger; and
send the encrypted portion of the trigger to be included in a signal including the trigger.

29. The apparatus of claim 28, wherein encrypting a portion of the trigger comprises encrypting a uniform resource locator portion of the trigger.

30. The apparatus of claim 28, wherein encrypting a portion of the trigger comprises inserting an activation date and/or a deactivation date into the encrypted portion of the trigger.

31. A machine-readable medium having stored thereon a plurality of executable instructions, the plurality of instructions comprising instructions to:
determining whether a received signal includes a trigger;
decrypting a portion of the trigger; and
if the decrypted portion meets predetermined criteria, allowing display of an enhancement within the trigger to a user.

32. A machine-readable medium having stored thereon a plurality of executable instructions, the plurality of instructions comprising instructions to:
receive at least a portion of a trigger;
encrypt the portion of the trigger; and
send the encrypted portion of the trigger to be included in a signal including the trigger.
